(19) United States
(12) Patent Application Publication
(10) Pub. No.: US 2016/0214410 A1
(43) Pub. Date: Jul. 28, 2016

(54) MEDIUM SUPPORT UNIT, RECORDING APPARATUS, AND MEDIUM SUPPORTING METHOD

(71) Applicant: SEIKO EPSON CORPORATION, Tokyo (JP)

(72) Inventor: Nobuhiko HAMADA, Shiojiri-shi (JP)

(21) Appl. No.: 14/996,638

(22) Filed: Jan. 15, 2016

(30) Foreign Application Priority Data
Jan. 26, 2015 (JP) 2015-012315

(51) Int. Cl. B41J 11/58

(52) U.S. Cl. CPC B41J 11/58

(57) ABSTRACT

A medium support unit includes a support portion capable of supporting a medium and a holder portion capable of holding the medium supported by the support portion. The support portion has a facing portion in a partial region that is a portion of a facing region that faces, when the support portion is combined with the holder portion, the holder portion in a supporting direction in which the support portion supports the medium. The facing region includes a void region in which the facing portion is absent and which allows a portion of the medium supported by the support portion and held by the holder portion to move.

### BACKGROUND

1. Technical Field

The present invention relates to a medium support unit, a recording apparatus, and a medium supporting method.

2. Related Art

Medium support units equipped with a holder portion capable of holding a medium supported by a support portion are known to have been used. Due to the holder portion that holds a medium, the medium can be set while being restrained from lifting off the support surface.

For example, JP-A-2013-227089 discloses a medium support unit that includes a medium-setting tray as a support portion and a frame as a holder portion capable of pressingly holding a medium against the entire perimeter portion of the medium-setting tray. Note that the medium-setting tray of the medium support unit has along its entire perimeter an edge portion that receives the frame.

However, in the case where an edge portion for receiving the holder portion is formed on the entire perimeter portion of the support portion, even though a medium is set on the support portion while being restrained from lifting off, problems may arise, for example, when the medium swells as the medium absorbs moisture from the air or as ink is deposited. In such cases, since this construction does not provide any space or the like into or through which the swelling medium is allowed to move or shift, the medium may possibly lift off the support portion.

### SUMMARY

An advantage of some aspects of the invention is that, in a medium support unit that includes a holder portion capable of holding a medium supported by a support portion, lift-off of the medium is inhibited.

According to a first aspect of the invention, a medium support unit includes a support portion capable of supporting a medium and a holder portion capable of holding the medium supported by the support portion. The support portion has a facing portion in a partial region that is a portion of a facing region that faces, when the support portion is combined with the holder portion, the holder portion in a supporting direction in which the support portion supports the medium. The facing region includes a void region in which the facing portion is absent and which allows a portion of the medium supported by the support portion and held by the holder portion to move.

In the medium support unit according to the first aspect of the invention, the facing portion may be provided on an edge portion of the support portion.

In this medium support unit, the void region may be formed by the facing portion provided on less than an entire perimeter length of the edge portion.

In the foregoing medium support unit, the holder portion may have a frame shape.

In the foregoing medium support unit, a void region-side end portion of the facing portion may have an acute angle in a view from the supporting direction.

In the foregoing medium support unit, the partial region of the facing region may have a larger area than the void region.

In the foregoing medium support unit, the void region may include at least a portion of a bounding line segment of the support portion in a view from the supporting direction and the medium support unit may be constructed to allow an operation of supporting the medium to be performed from a location at a side opposite to the bounding line segment.

According to a second aspect of the invention, a recording apparatus includes the medium support unit according to the first aspect of the invention and a recording portion capable of performing recording on the medium supported by the medium support unit.

This recording apparatus may further include a movement portion capable of moving the medium support unit relative to the recording portion. The recording apparatus may be capable of performing recording, by using the recording portion, on the medium supported by the medium support unit while moving the medium support unit in a first direction by the movement portion. In the medium support unit, the void region may be provided at a rear end side in the first direction.

According to a third aspect of the invention, a medium supporting method for a medium support unit that includes a support portion capable of supporting a medium and a holder portion capable of holding the medium supported by the support portion is provided. The medium supporting method includes forming on the support portion a facing portion in a partial region that is a portion of a facing region that faces, when the support portion is combined with the holder portion, the holder portion in a supporting direction in which the support portion supports the medium and providing in the facing region a void region in which the facing portion is absent and which allows a portion of the medium supported by the support portion and held by the holder portion to move.

According to the invention, the medium support unit provided with the holder portion capable of holding a medium supported by the support portion is able to inhibit the medium from lifting off.

### BRIEF DESCRIPTION OF THE DRAWINGS

The invention will be described with reference to the accompanying drawings, wherein like numerals reference like elements.

FIG. 1 is a schematic perspective view of a recording apparatus according to an exemplary embodiment of the invention.

FIG. 2 is a schematic perspective view of the recording apparatus according to the exemplary embodiment of the invention.

FIG. 3 is a schematic front view of a recording apparatus according to an exemplary embodiment of the invention.

FIG. 4 is a schematic perspective view of a medium support unit according to Exemplary Embodiment 1 of the invention.

FIGS. 5A to 5C are schematic side sectional views presenting a medium support unit according to Exemplary Embodiment 1 of the invention.

FIGS. 6A to 6I are schematic plan views presenting medium support units according to Exemplary Embodiments 1 to 9 of the invention.

FIGS. 7A to 7C are schematic side sectional views presenting a related-art medium support unit.

### DETAILED DESCRIPTION OF EXEMPLARY EMBODIMENTS

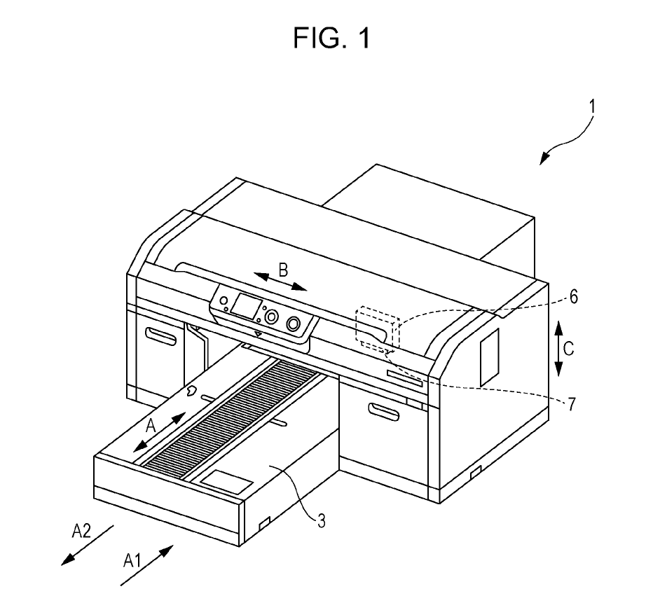

### Exemplary Embodiment 1 (FIGS. 1 to 6I)

A medium support unit 2 according to Exemplary Embodiment 1 of the invention and a recording apparatus 1 according to an exemplary embodiment that includes the medium support unit 2 will be described in detail with reference to the drawings.

First, the recording apparatus 1 of this exemplary embodiment will be generally described.

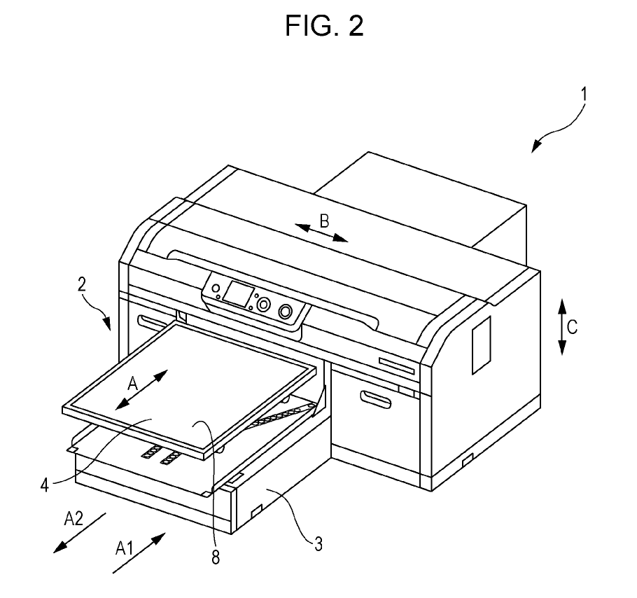

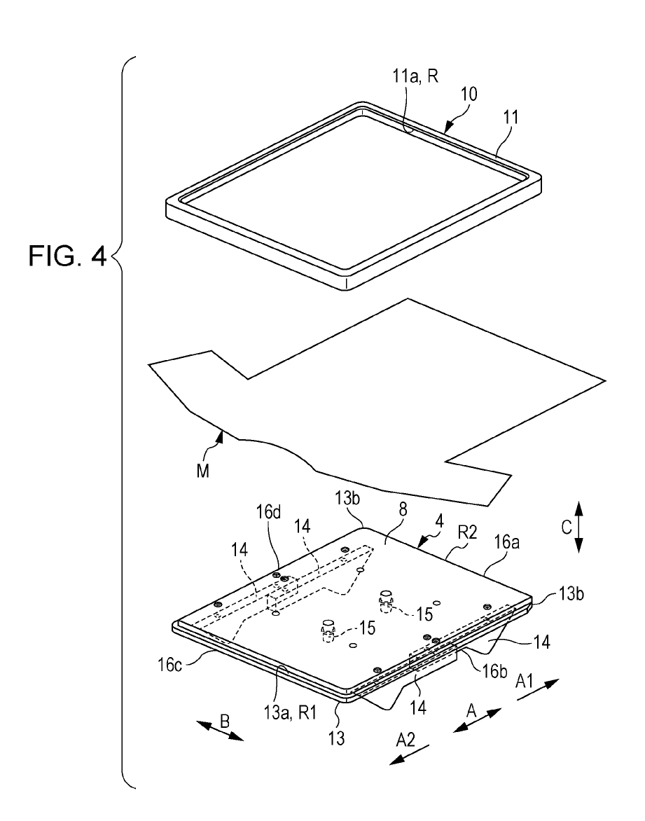

FIGS. 1 and 2 are schematic perspective views of the recording apparatus 1 according to Exemplary Embodiment 1 of the invention. Of these, FIG. 1 presents a state in which a tray 4 provided as a support portion for a medium M (see FIG. 4) in the recording apparatus 1 of this exemplary embodiment is at a recording start position and FIG. 2 presents a state in which the tray 4 is at a setting position at which to set the medium M onto the tray 4.

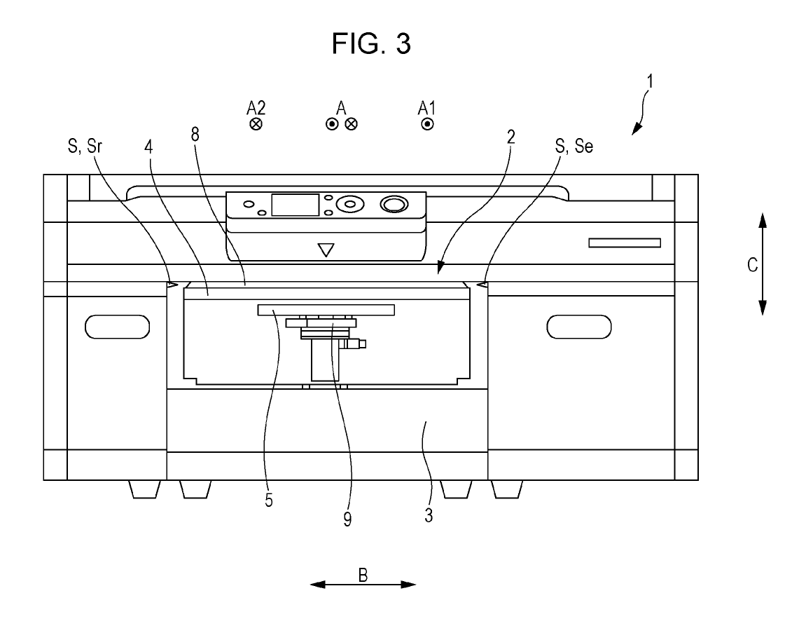

FIG. 3 is a schematic front view of the recording apparatus 1 according to this exemplary embodiment.

The recording apparatus 1 of this exemplary embodiment includes a medium support unit 2 that moves in movement directions A while supporting the medium M on a support surface 8. The medium support unit 2 includes the tray 4 that is a support portion for the medium M. The recording apparatus 1 includes a medium transport portion 3 that transports in the movement directions A the medium M supported on the tray 4. Besides, the tray 4 is mounted on a stage 5. The tray 4 is moved together with the stage 5 in a supporting direction C (height direction) for the medium M by rotating a rotation lever 9.

Furthermore, inside a main body of the recording apparatus 1 there is provided a recording head 7 capable of performing recording on the medium M by ejecting ink onto the medium M. In this exemplary embodiment, the recording head 7 corresponds to a recording portion that is capable of executing recording on a medium M. The recording apparatus 1 of this exemplary embodiment forms a desired image by ejecting ink from the recording head 7 onto the medium M supported by the tray 4 while moving the recording head 7 back and forth in intersecting directions B that intersect the movement directions A by moving a carriage 6 on which the recording head 7 is provided back and forth in the intersecting directions B.

Incidentally, as for the recording apparatus 1 of this exemplary embodiment, the setting position (corresponding to the state shown in FIG. 2) at which to set a medium M onto the tray 4 is at a front or near side in FIGS. 1 and 2 (a bottom left side in these drawings). Then, the recording apparatus 1 moves the tray 4 with the medium M set thereon in a direction A1 that is one of the movement directions A from the medium setting position to the recording start position (corresponding to the state shown in FIG. 1) that is at a back or far side in FIGS. 1 and 2 (a top right side in these drawings). After that, the recording apparatus 1 performs recording while moving the tray 4 in a direction A2 that is the other one of the movement directions A.

Note that although the recording apparatus 1 of this exemplary embodiment includes the recording head 7 that performs recording while moving back and forth in the intersecting directions B, the invention is also applicable to a recording apparatus that includes a so-called line head in which a plurality of nozzles that eject ink are arranged in the intersecting directions B that intersect the movement directions A.

Note that the “line head” is a recording head in which a region where nozzles are formed in the intersecting directions B that intersect the movement directions A of the medium M is provided so as to cover the entire width of the medium M in the intersecting directions B and which is for use in a recording apparatus that forms images by moving a recording head and a recording medium M relative to each other. Incidentally, the region of the line head's nozzles extending in the intersecting directions B does not necessarily need to be capable of covering the entire widths of all types of media M that can be handled by the recording apparatus in the intersecting directions B.

Furthermore, although the recording head 7 in this exemplary embodiment is a recording portion capable of recording by ejecting ink in the form of liquid onto the medium M, the recording head in the invention is not limited to such a recording portion; for example, a transfer type recording portion that performs recording by transferring color materials to a recording medium M may also be used.

Furthermore, the recording apparatus 1 of this exemplary embodiment includes a sensor S as presented in FIG. 3 and is configured to be capable of detecting the presence or absence of abnormality regarding the gap between the recording head 7 and the medium M supported by the tray 4 (abnormality in which the gap between the medium M and the recording head 7 is excessively small).

The sensor S includes a light emitting portion Se and a light receiving portion Sr. The sensor S emits light from the light emitting portion Se toward the light receiving portion Sr and detects the presence or absence of abnormality regarding the gap on the basis of whether the light receiving portion Sr has received light. However, this construction is not restrictive.

Next, the medium support unit 2 of Exemplary Embodiment 1 of the invention will be described in detail.

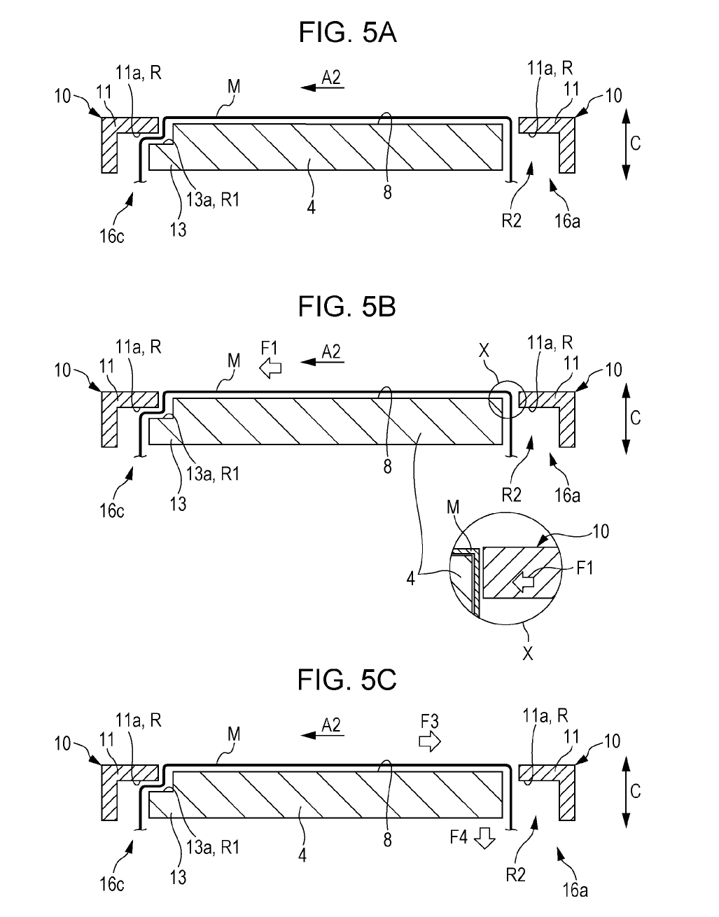

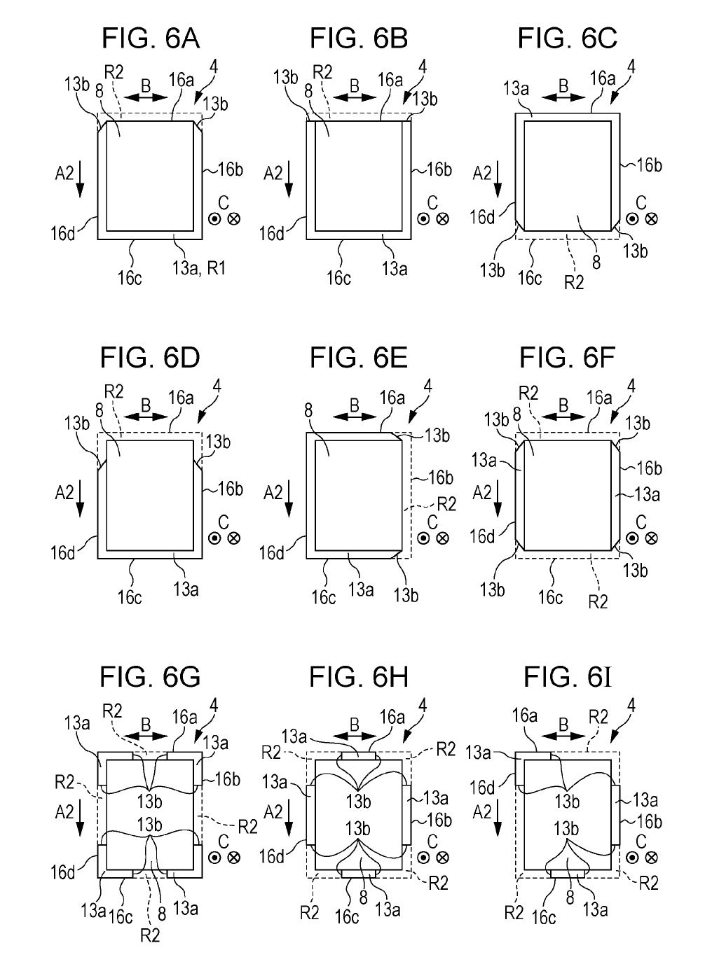

FIG. 4 is a schematic perspective view presenting the medium support unit 2 of this exemplary embodiment. FIGS. 5A to 5C are schematic side sectional views presenting the medium support unit 2 of this exemplary embodiment. Of FIGS. 6A to 6I, FIG. 6A is a schematic plan view presenting the medium support unit 2 of this exemplary embodiment.

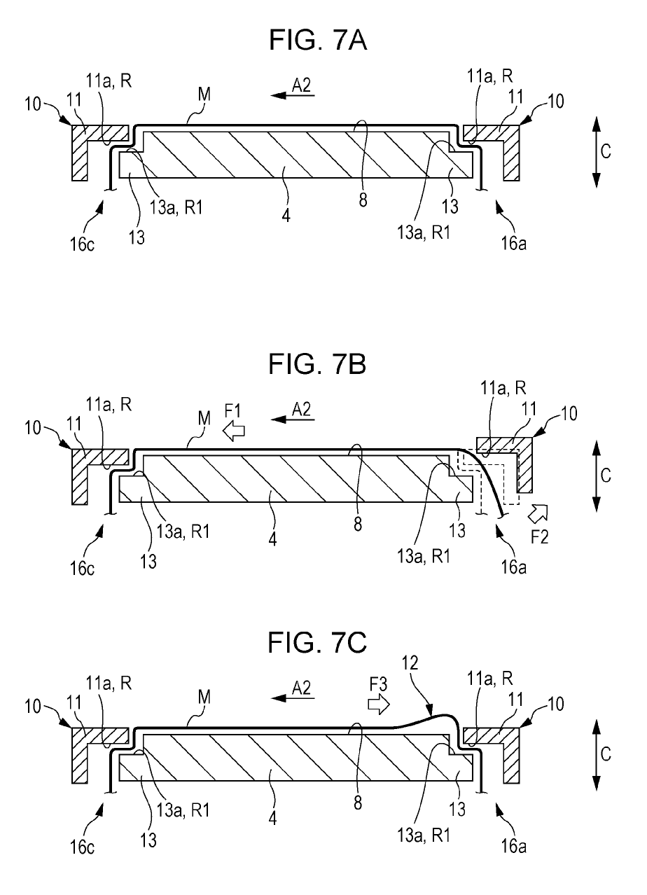

FIGS. 7A to 7C are schematic side sectional views presenting a related-art medium support unit, corresponding to FIGS. 5A to 5C presenting the medium support unit 2 of Exemplary Embodiment 1.

The medium support unit 2 of this exemplary embodiment includes the tray 4 that is a support portion capable of supporting the medium M as mentioned above. Furthermore, as presented in FIG. 4 and FIGS. 5A to 5C, the medium support unit 2 includes a holder portion 10 capable of holding the medium M supported by the tray 4. The medium support unit 2 of this exemplary embodiment is, as presented in FIG. 4, constructed so that the medium M is placed on the support surface 8 of the tray 4 and the medium M placed on the tray 4 is firmly held by combining the holder portion 10 with the tray 4.

As shown in FIGS. 6A to 6I, with respect to the tray 4, one of two sides in the movement directions A is termed A side 16a and the other one of the two sides in the movement directions A is termed C side 16c. Furthermore, with respect to the tray 4, one of two sides in the intersecting directions B is termed B side 16b and the other one of the two sides in the intersecting directions B is termed D side 16d. When the tray 4 has a quadrangular shape in a plan view as in this exemplary embodiment (that includes a substantially quadrangular shape with its corners rounded or chamfered), the A side 16a, the B side 16b, the C side 16c, and the D side 16d may be termed first bounding line segment side, second bounding line segment side, third bounding line segment side, and fourth bounding line segment side, respectively.

FIG. 5A presents a state subsequent to a state shown in FIG. 4 (in which the medium M is about to be set onto the tray 4), that is, a state in which the holder portion 10 has been combined with the tray 4, with the medium M set on the tray 4. FIG. 5B presents a state in which prior to the recording in the recording apparatus 1 in the state shown in FIG. 5A, an operator has pulled the medium M in a direction F1 from the C side 16c of the tray 4, of the A side 16a, the B side 16b, the C side 16c, and the D side 16d of the tray 4 (from the side closer to the position at which to set the medium M), so that there is no longer a lift-off 12 of the medium M (see FIG. 7C) formed at the time of combining the holder portion 10 with the tray 4, with the medium M set thereon. FIG. 5C presents a state in which as the recording in the recording apparatus 1 begins in the state shown in FIG. 5B, the medium M swells and part of the swollen medium M shifts in a direction F4 from the A side 16a.

Furthermore, as presented in FIG. 4 and FIGS. 5A to 5C, the tray 4 has an eave-facing portion 13 that is formed in a partial region R1 that is a part of an eave-facing region R that faces a lower surface 11a of an eave portion 11 of the holder portion 10 in a supporting direction C in which the medium M is supported when the holder portion 10 is combined with the tray 4. More specifically, a portion of an upper surface 13a of the eave-facing portion 13 corresponds to the partial region R1 of the eave-facing region R that faces the lower surface 11a of the eave portion 11 of the holder portion 10. As presented in FIG. 5C, the eave-facing region R includes a void region R2 in which the eave-facing portion 13 is not formed and through which a portion of the medium M supported by the tray 4 and held by the holder portion 10 is allowed to move in a direction F4. Specifically, the void region R2 is a region through or into which the medium M, for example, the swollen medium M, is allowed to move or shift (a relief region). Thus, the medium support unit 2 of this exemplary embodiment is constructed to be able to restrain formation of the lift-off 12 of the medium M when the medium M swells. Therefore, even when the medium M swells, the recording apparatus 1 of this exemplary embodiment is able to inhibit formation of the lift-off 12 of the medium M and perform appropriate recording.

In other words, in the medium support unit 2 of this exemplary embodiment, the tray 4 is provided with the eave-facing portion 13 that extends in the partial region R1 that is a portion of the eave-facing region R that faces the holder portion 10 in the medium M-supporting direction C when the tray 4 is combined with the holder portion 10. The eave-facing region R includes the void region R2 in which the eave-facing portion 13 is not formed and in which a portion of the medium M supported on the tray 4 and held by the holder portion 10 is allowed to move in the direction F4. Since the void region R2 is formed to function as a relief region for allowing the swollen medium M to shift, formation of the lift-off 12 of the medium M at the time of swelling can be inhibited.

As for the medium support unit 2 of this exemplary embodiment, if an operator pulls the medium M in the direction F1 from the C side 16c in a state where the holder portion 10 has been combined with the tray 4 with the medium M placed on the tray 4 (the state shown in FIG. 5A) so as to eliminate the lift-off 12 of the medium M, the holder portion 10 also moves in the direction F1 as presented in an enlarged partial view X in FIG. 5B. Thus, as the medium M is pulled, the holder portion 10 is brought into firm contact with the tray 4 at the A side 16a so that the holder portion 10 and the tray 4 clamp the medium M, restraining the entire medium M from moving in the direction F1 (the medium M from slipping off the tray 4).

In contrast, in the related-art medium support unit, when the medium M is pulled in the direction F1 from the C side 16c in the state in which the holder portion 10 has been combined with the tray 4, with the medium M placed on the tray 4 (a state shown in FIG. 7A), so as to eliminate the lift-off 12 of the medium M, force acts on the holder portion 10 in a direction F2 as presented in FIG. 7B. In the state as shown in FIG. 7B, the clamping force on the medium M exerted by the holder portion 10 and the tray 4 at the A side 16a weakens so that the entire medium M easily moves in the direction F1. Furthermore, there arises a risk of the holder portion 10 coming apart from the tray 4.

Furthermore, the medium support unit 2 of this exemplary embodiment is provided with the void region R2 that corresponds to the relief region for allowing the swollen medium M to move or shift, formation of the lift-off 12 of the medium M can be restrained when the medium M swells. For example, as presented in FIG. 5C, even if the medium M swells in substantially a direction F3 as the recording apparatus 1 performs recording, a portion of the medium M can shift in the direction F4 from the A side 16a, so that formation of the lift-off 12 of the medium M supported on the tray 4 can be inhibited.

On the other hand, in the related-art medium support unit, an eave-facing portion 13 is formed continuously, without a break, on the entire length of edge portions on the A side 16a, the B side 16b, the C side 16c, and the D side 16d. Therefore, for example, if, as presented in FIG. 7C, the medium M swells in substantially the direction F3 as the recording apparatus 1 performs recording, a portion of the swollen medium M cannot be released at the A side 16a and there sometimes forms a lift-off 12 of the medium M supported on the tray 4.

As presented in FIG. 4, FIGS. 5A to 5C, and FIG. 6A, in the medium support unit 2 of this exemplary embodiment, the eave-facing portion 13 is formed on edge portions of the tray 4 (except on the A side 16a). Therefore, the medium M can be held against the edge portions of the tray 4 by the holder portion 10. The medium support unit 2 is thus constructed so that it is possible to set the medium M on the tray 4 while effectively restraining of the medium M from lifting off.

In other words, the holder portion 10 in this exemplary embodiment has a frame shape, and faces the eave-facing portion 13 formed on the edge portions of the tray 4 in the partial region R1 in the eave-facing region R that faces the holder portion 10 when the holder portion 10 is combined with the tray 4. Therefore, the medium M can be held against the edge portions of the tray 4, and it is possible to set the medium M on the tray 4 while effectively inhibiting the medium M from lifting off.

Note that the “frame shape” is not limited to a configuration that is able to fringe the entire perimeter of a thing continuously without a break but is meant to include a configuration that is able to fringe the perimeter of a thing substantially continuously despite forming breaks.

Furthermore, as presented in FIG. 4, the void region R2 is formed along the edge portion at the A side 16a, of the edge portions of the tray 4 at the A side 16a, the B side 16b, the C side 16c, and the D side 16d, that is, along a portion of the edge portions (the perimeter portion) of the tray 4. In other words, the void region R2 is formed by forming the eave-facing portion 13 so that the length of the eave-facing portion 13 is shorter than the entire perimeter of the tray 4. Therefore, the void region R2 can be easily formed. At the same time, the medium M can be held along edge portions of the tray 4, so that it is possible to set the medium M on the tray 4 while effectively inhibiting the medium M from lifting off.

Furthermore, as presented in FIG. 4 and FIG. 6A, each of two end portions 13b of the eave-facing portion 13 that are relatively close to the void region R2 has an acute angle vertex when viewed in either one of supporting directions C. More specifically, the eave-facing portion 13 is formed so that, when viewed in either one of the supporting directions C, the eave-facing portion 13 becomes narrower toward each of the void region R2-side end portions 13b. Due to this configuration, the medium M is less likely to get caught. That is, this substantially prevents the medium M from getting caught on the void region R2-side end portions 13b of the eave-facing portion 13, for example, when the swelling medium M is allowed to shift through the void region R2.

A configuration in which the void region R2-side end portions 13b have been subjected to, for example, a rounding process (a corner-chamfering process) may also be adopted. This configuration also makes it possible to substantially prevent the medium M from getting caught when a portion of the medium M is allowed to shift through the void region R2, for example, at the time of the swelling of the medium M.

Furthermore, as presented in FIG. 6A, the partial region R1 of the eave-facing region R has a larger area than the void region R2. That is, in the eave-facing region R, a region in which the eave-facing portion 13 is formed has a larger area than the void region in which the eave-facing portion 13 is not formed. This construction substantially prevents a situation in which the area of the region in which the eave-facing portion 13 is formed is small so that the effect of the holder portion 10 holding the medium M is insufficient. Furthermore, if the region in which the eave-facing portion 13 is formed is small, the holder portion 10 is likely to become unstable relative to the tray 4. Thus, the above-described construction restrains the holder portion 10 from becoming unstable relative to the tray 4.

Furthermore, the medium support unit 2 of this exemplary embodiment is constructed so that an operation of supporting the medium M on the tray 4 (a setting operation in which the medium M is set onto the tray 4) can be carried out from the C side 16c of the tray 4. Concretely, a side of the tray 4 shown in FIG. 2 toward the lower left corner of the sheet of the drawing is the C side 16c of the tray 4. Therefore, as presented in FIG. 4 and FIG. 6A, it can be said that the void region R2 includes at least a portion of the A-side-16a bounding line segment of the tray 4 in a view from the supporting direction C. It can be said that the medium support unit 2 allows the medium M-supporting operation to be performed at a location adjacent to a bounding line segment of the tray 4 opposite to the A-side-16a bounding line segment of the tray 4. That is, it can be said that an operator who works with the medium support unit 2 is allowed to execute the operation of supporting the medium M on the medium support unit 2, with the void region R2 being the farthest from an operation location at which to perform the medium M-supporting operation (a location at the lower left side of the recording apparatus 1 in FIG. 2).

If, during the operation of supporting the medium M, the medium M has a lift-off 12 at a location remote from the operation location at which to perform the supporting operation, it generally takes time and effort to fix that problem (eliminate the lift-off 12). However, since the void region R2 is formed at a location remote from the operation location, the lift-off 12 of the medium M, even if formed at a location remote from the operation location, can be easily released due to the void region R2 (can be inhibited). For example, even if a lift-off 12 occurs on an A-side-16a portion of the tray 4 (at a location remote from the operation location), the lift-off 12 can be released via the void region R2 due to the weight of the medium M. Therefore, it can be said that the medium support unit 2 of this exemplary embodiment is constructed so as to achieve high efficiency of the operation of eliminating the lift-off 12 of the medium M.

The recording apparatus 1 of this exemplary embodiment includes the medium transport portion 3 provided as a movement portion capable of moving the medium support unit 2 in the movement directions A relative to the recording head 7. While moving the medium support unit 2 in a direction A2 that is a first direction of the two movement directions A by using the medium transport portion 3, the recording apparatus 1 is able to perform recording on the medium M supported by the medium support unit 2 by using the recording head 7.

Note that, in the medium support unit 2, the void region R2 is formed at a rear end side in the direction A2. Therefore, in the recording apparatus 1 of this exemplary embodiment that performs recording by ejecting ink onto the medium M, even when, as recording proceeds, the medium M swells in the direction A2, one of the movement directions of the medium support unit 2, the void region R2 formed at the rear end side in the direction A2 efficiently releases (inhibits the remaining of) the lift-off 12 of the medium M.

Incidentally, as presented in FIG. 4, the tray 4 in this exemplary embodiment includes leg portions 14 that are used when the tray 4 is placed on a floor or the like after being removed from the stage 5 and positioning portions 15 capable of positioning the tray 4 relative to the stage 5. However, the construction of the tray 4 is not particularly limited.

### Exemplary Embodiments 2 to 9 (FIGS. 6B to 6I)

Medium support units 2 according Exemplary Embodiments 2 to 9 of the invention will be described.

FIGS. 6A to 6I are schematic plan views of medium support units 2 according to Exemplary Embodiments 1 to 9 of the invention. FIG. 6A, as mentioned above, presents the medium support unit 2 of Exemplary Embodiment 1. FIGS. 6B to 6I present the medium support units 2 of Exemplary Embodiments 2 to 9. In these drawings, component members comparable to those of Exemplary Embodiment 1 described above are denoted by the same reference characters.

The medium support unit 2 of Exemplary Embodiment 2 presented in FIG. 6B has substantially the same construction as the medium support unit 2 of Exemplary Embodiment 1, except that the eave-facing portion 13 in Exemplary Embodiment 2 does not become narrower in width toward the void region R2-side end portions 13b in a view from the supporting direction C.

In the medium support unit 2 of Exemplary Embodiment 3 presented in FIG. 6C, a void region R2 is not provided at the A side 16a of the tray 4 but provided at the C side 16c of the tray 4.

In the medium support unit 2 of Exemplary Embodiment 4 presented in FIG. 6D, a void region R2 is provided at the A side 16a of the tray F and extends further into portions of the regions at the B side 16b and the D side 16d of the tray.

In the medium support unit 2 of Exemplary Embodiment 5 presented in FIG. 6E, a void region R2 is provided not at the A side 16a of the tray 4 but at the B side 16b of the tray 4.

In the medium support unit 2 of Exemplary Embodiment 6 presented in FIG. 6F, void regions R2 are provided at the C side 16c of the tray 4 as well as at the A side 16a of the tray 4.

Furthermore, in the medium support unit 2 of Exemplary Embodiment 7 presented in FIG. 6G, void regions R2 are provided along middle portions of the tray on the A side 16a, the B side 16b, the C side 16c, and the D side 16d.

In the medium support unit 2 of Exemplary Embodiment 8 presented in FIG. 6H, void regions R2 are provided around four corners of the tray 4.

The medium support unit 2 of Exemplary Embodiment 9 presented in FIG. 6I is asymmetrical when viewed in any direction, whereas the medium support units 2 of Exemplary Embodiments 1 to 8 are each symmetrical when viewed in a certain direction.

Incidentally, the invention is not limited to the foregoing exemplary embodiments but can be modified and changed in various manners within the scope of the invention described in the appended claims, and such modifications and changes are, of course, encompassed within the scope of the invention.

The invention has been described in detail above with reference to the specific exemplary embodiments. Features of the invention will be recapitulated below.

A medium support unit 2 according to a first exemplary embodiment of the invention includes a support portion 4 capable of supporting a medium M and a holder portion 10 capable of holding the medium M supported by the support portion 4. The support portion 4 has a facing portion 13 in a partial region R1 that is a portion of a facing region R that faces, when the support portion 4 is combined with the holder portion 10, the holder portion 10 in a supporting direction C in which the support portion 4 supports the medium M. The facing region R includes a void region in which the facing portion 13 is absent and which allows a portion of the medium M supported by the support portion 4 and held by the holder portion 10 to move.

According to this exemplary embodiment, the support portion 4 is provided with the facing portion 13 formed in the partial region R1 that is a portion of the facing region R that faces the holder portion 10 in the medium M-supporting direction C when the support portion 4 is combined with the holder portion 10. In the facing region R, the void region R2 in which the facing portion 13 is not provided and which allows a portion of the medium M supported by the support portion 4 and held by the holder portion 10 to move is provided. That is, the void region R2 serves as a region that allows movement or shift of the medium M, for example, the swollen medium M (as a relief region). Therefore, a lift-off 12 of the medium M can be inhibited from remaining.

In a medium support unit 2 according to a second exemplary embodiment of the invention based on the first exemplary embodiment, the facing portion 13 is provided on an edge portion of the support portion 4.

According to this exemplary embodiment, the facing portion 13 is provided on the edge portion of the support portion 4. Therefore, the medium M can be held along the edge portion of the support portion 4, so that it is possible to set the medium M on the support portion 4 while effectively inhibiting the lift-off 12 of the medium M.

In a medium support unit 2 according to a third exemplary embodiment of the invention based on the second exemplary embodiment, the void region R2 is formed by the facing portion 13 provided on less than an entire perimeter length of the edge portion.

According to this exemplary embodiment, the void region R2 is formed as the facing portion 13 is provided along less than the perimeter length of the edge portion all around the support portion 4. That is, the void region R2 is provided on a portion of the perimeter of the support portion 4. Therefore, the void region R2 can be easily formed. Furthermore, because the medium M can be held along the edge portion of the support portion 4, it is possible to set the medium M on the support portion 4 while effectively inhibiting the lift-off 12 of the medium M.

In a medium support unit 2 according to a fourth exemplary embodiment of the invention based on the second or third exemplary embodiment, the holder portion 10 has a frame shape.

According to this exemplary embodiment, the holder portion 10 has a frame shape. That is, the holder portion 10, when combined with the support portion 4, faces the facing portion 13 that is provided on the edge portion of the support portion 4. Therefore, the medium M can be held along the edge portion of the support portion 4, so that it is possible to set the medium M on the support portion 4 while effectively inhibiting the medium M from lifting off.

Note that the “frame shape” is not limited to a configuration that is able to fringe the entire perimeter of a thing continuously without a break but is meant to include a configuration that is able to fringe the perimeter of a thing substantially continuously despite forming breaks.

In a medium support unit 2 according to a fifth exemplary embodiment of the invention based on one of the first to fourth exemplary embodiments, a void region-R2-side end portion 13b of the facing portion 13 has an acute angle in a view from the supporting direction C.

According to this exemplary embodiment, the void region R2-side end portions 13b of the facing portion 13 is configured to have an acute angle in a view from the supporting direction C. That is, the eave-facing portion 13 is formed so that, when viewed in the supporting direction C, the facing portion 13 becomes narrower in width toward the void region R2-side end portion 13b. Therefore, it becomes possible to avoid a construction in which the medium M easily gets caught. That is, it becomes possible to substantially prevent the medium M from getting caught on the void region R2-side end portions 13b of the facing portion 13, for example, when the swelling medium M is allowed to shift through the void region R2.

In a medium support unit 2 according to a sixth exemplary embodiment of the invention based on any one of the first to fifth exemplary embodiments, the partial region R1 of the facing region R has a larger area than the void region R2.

According to this exemplary embodiment, the area of the partial region R1 of the facing region R is larger than the area of the void region R2. That is, in the facing region R, a region in which the facing portion 13 is formed has a larger area than the void region in which the facing portion 13 is not formed. This construction substantially prevents a situation where the area of the region in which the facing portion 13 is formed is small so that the effect of the holder portion 10 holding the medium M is insufficient. Furthermore, if the region in which the facing portion 13 is formed is small, the holder portion 10 is likely to become unstable relative to the tray 4. Thus, the above-described construction restrains the holder portion 10 from becoming unstable relative to the tray 4.

In a medium support unit 2 according to a seventh exemplary embodiment of the invention based on any one of the first to sixth exemplary embodiments, the void region R2 includes at least a portion of a bounding line segment of the support portion 4 in a view from the supporting direction C. Furthermore, the medium support unit 2 is constructed to allow an operation of supporting the medium M to be performed from a location at a side opposite to the bounding line segment.

According to this exemplary embodiment, the void region R2 is formed so as to include at least a portion of a bounding line segment of the support portion 4 in a view from the supporting direction C and, furthermore, the medium support unit 2 allows the medium M-supporting operation (the setting operation in which the medium M is set onto the support portion 4) to be performed from a location at a side opposite to that bounding line segment. That is, an operator who works with the medium support unit 2 is allowed to execute the operation of supporting the medium M on the medium support unit 2, with the void region R2 being the farthest from the operation location at which to perform the medium M-supporting operation. If, during the medium M-supporting operation, the medium M has a lift-off 12 at a location remote from the operation location at which to perform the supporting operation, it generally takes time and effort to fix that problem (eliminate the lift-off 12). However, since the void region R2 is formed at a location remote from the operation location, the lift-off 12 of the medium M, even if formed at a location remote from the operation location, can be easily released (inhibited from remaining) due to the void region R2 (i.e., the operation of eliminating the lift-off 12 can be easily carried out).

A recording apparatus 1 according to an eighth exemplary embodiment of the invention includes the medium support unit 2 according to any one of the first to seventh exemplary embodiments and a recording portion 7 capable of performing recording on the medium M supported by the medium support unit 2.

According to this exemplary embodiment, it is possible to perform recording while inhibiting the lift-off 12 of the medium M.

A recording apparatus 1 according to a ninth exemplary embodiment of the invention based on the eighth exemplary embodiment further includes a movement portion 3 capable of moving the medium support unit 2 relative to the recording portion 7. Furthermore, the recording apparatus 1 is capable of performing recording, by using the recording portion 7, on the medium M supported by the medium support unit 2 while moving the medium support unit 2 in a first direction A2 by the movement portion 3. In the medium support unit 2, the void region R2 is provided at a rear end side in the first direction A2.

According to this exemplary embodiment, in the medium support unit 2, the void region R2 is formed at the rear end side in the first direction A2. Therefore, in the recording apparatus 1 that performs recording by, for example, ejecting a liquid, such as ink, onto the medium M, even when, as recording proceeds, the medium M swells in the first direction A2, one of the movement directions of the medium support unit 2, the void region R2 formed at the rear end side in the direction A2 efficiently releases (inhibits the remaining of) the lift-off of the medium M.

A medium supporting method according to a tenth exemplary embodiment of the invention is a medium supporting method for a medium support unit 2 that includes a support portion 4 capable of supporting a medium M and a holder portion 10 capable of holding the medium M supported by the support portion 4. The medium supporting method includes forming on the support portion 4 a facing portion 13 in a partial region R1 that is a portion of a facing region R that faces, when the support portion 4 is combined with the holder portion 10, the holder portion 10 in a supporting direction C in which the support portion 4 supports the medium M and providing in the facing region R a void region R2 in which the facing portion 13 is absent and which allows a portion of the medium M supported by the support portion 4 and held by the holder portion 10 to move.

According to this exemplary embodiment, the support portion 4 is provided with the facing portion 13 formed in the partial region R1 that is a portion of the facing region R that faces the holder portion 10 in the medium M-supporting direction C when the support portion 4 is combined with the holder portion 10. Furthermore, a portion of the medium M supported by the support portion 4 and held by the holder portion 10 is allowed to move into or through the void region R2 in which the facing portion 13 is not formed. That is, by forming the void region R2, a region through or into which the medium M, for example, the swollen medium M, is allowed to move or shift (a relief region) is formed. Therefore, lift-off of the medium M can be inhibited.

The entire disclosure of Japanese Patent Application No. 2015-012315, filed Jan. 26, 2015 is expressly incorporated reference herein.

What is claimed is:

1. A medium support unit comprising:
a support portion capable of supporting a medium; and
a holder portion capable of holding the medium supported by the support portion,
wherein the support portion has a facing portion in a partial region that is a portion of a facing region that faces, when the support portion is combined with the holder portion, the holder portion in a supporting direction in which the support portion supports the medium, and
wherein the facing region includes a void region in which the facing portion is absent and which allows a portion of the medium supported by the support portion and held by the holder portion to move.

2. The medium support unit according to claim 1, wherein the facing portion is provided on an edge portion of the support portion.

3. The medium support unit according to claim 2, wherein the void region is formed by the facing portion provided on less than an entire perimeter length of the edge portion.

4. The medium support unit according to claim 2, wherein the holder portion has a frame shape.

5. The medium support unit according to claim 1, wherein a void region-side end portion of the facing portion has an acute angle in a view from the supporting direction.

6. The medium support unit according to claim 1, wherein the partial region of the facing region has a larger area than the void region.

7. The medium support unit according to claim 1, wherein:
the void region includes at least a portion of a bounding line segment of the support portion in a view from the supporting direction; and
the medium support unit is constructed to allow an operation of supporting the medium to be performed from a location at a side opposite to the bounding line segment.

8. A recording apparatus comprising:
the medium support unit according to claim 1; and
a recording portion capable of performing recording on the medium supported by the medium support unit.

9. The recording apparatus according to claim 8, further comprising a movement portion capable of moving the medium support unit relative to the recording portion,
wherein the recording apparatus is capable of performing recording, by using the recording portion, on the medium supported by the medium support unit while moving the medium support unit in a first direction by the movement portion, and
wherein in the medium support unit, the void region is provided at a rear end side in the first direction.

10. A medium supporting method for a medium support unit that includes a support portion capable of supporting a medium and a holder portion capable of holding the medium supported by the support portion, the medium supporting method comprising:
forming on the support portion a facing portion in a partial region that is a portion of a facing region that faces, when the support portion is combined with the holder portion, the holder portion in a supporting direction in which the support portion supports the medium; and
providing in the facing region a void region in which the facing portion is absent and which allows a portion of the medium supported by the support portion and held by the holder portion to move.
